(19) United States
(12) Patent Application Publication
(10) Pub. No.: US 2025/0155161 A1
(43) Pub. Date: May 15, 2025

(54) Systems and Methods for a Water Heater with an Insulation Dam

(71) Applicant: Rheem Manufacturing Company, Atlanta, GA (US)

(72) Inventors: Gary Dale Flatness,, JR., Montgomery, AL (US); Grady Britton, Montgomery, AL (US)

(21) Appl. No.: 18/942,931

(22) Filed: Nov. 11, 2024

Related U.S. Application Data
(60) Provisional application No. 63/647,670, filed on May 15, 2024.
(60) Provisional application No. 63/598,506, filed on Nov. 13, 2023.

(51) Int. Cl. F24H 1/18; B29C 44/12; B29C 44/18

(52) U.S. Cl. CPC F24H 1/182; B29C 44/1247; B29C 44/18

(57) ABSTRACT

Systems and methods for water heater systems with an insulation dam for restricting flow of injectable insulation are provided. An insulation dam may be positioned around a bottom region of a water tank. A jacket may be formed around and offset from the combustion chamber and the water tank such that a void is created between and interior of the jacket and an exterior surface of the water tank, above the insulation dam. Injectable insulation such as an injectable foam may be inserted in the void to insulate the water tank. The insulation dam may prevent the injectable insulation from entering the area between the combustion chamber and the jacket. The insulation dam may be filled in an open-cell foam such that air may be vacuumed out from the insulation dam to compress the insulation dam before installation, and re-introduced into the insulation dam subsequent to installation to allow the insulation dam to expand again.

### CROSS-REFERENCE TO RELATED APPLICATIONS

This application claims priority to and benefit of U.S. provisional patent application No. 63/598,506 filed Nov. 13, 2023 and U.S. provisional patent application No. 63/647,670 filed May 15, 2024, both of which are herein incorporated by reference.

### TECHNICAL FIELD

The present disclosure is generally in the field of water heaters. For example, systems and methods are provided herein for water heaters with an insulation dam.

### BACKGROUND

Water heating systems such as gas water heaters may heat large volumes of water, retained in a water tank for use in residential settings, for example (as well as commercial settings). Such water heaters may include a water tank positioned above a combustion chamber having a gas burner. The gas burner may be selectively activated to apply heat to water in the water tank to cause the water to increase in temperature for distribution throughout a residential or commercial setting (e.g., house, apartment building, office building, etc.).

Gas water heaters are often cylindrical in shape with a generally cylindrical water tank and combustion chamber. To improve efficiency, water heaters typically are surrounded by insulation. For example, it may be desirable to insulate the water heater to prevent or reduce heat exchange between the outside environment and the heater water in the tank. Further, the combustion chamber may be insulated. The combustion chamber with the gas burner may reach high temperatures and may damage other components of the water heater if the temperature is not managed properly.

To facilitate heat retention in the water tank and manage heat generated by a combustion chamber, water heaters may include an insulation skirt that surrounds the combustion chamber.

### BRIEF DESCRIPTION OF THE DRAWINGS

FIG. 1 is a cross-sectional view of a water heater with an insulation dam and an insulating skirt in accordance with one or more exemplary embodiments of the disclosure.

FIG. 2 is a cross-sectional view of exemplary insulating portions of the water heart in accordance with one or more exemplary embodiments of the disclosure.

FIG. 3 is a perspective view an insulating assembly including an insulation dam and an insulating skirt, in accordance with one or more exemplary embodiments of the disclosure.

FIG. 4 is a top-down view of an insulation dam, in accordance with one or more exemplary embodiments of the disclosure.

FIG. 5 is a perspective view of another insulation dam, in accordance with one or more exemplary embodiments of the disclosure.

FIG. 6 is a perspective cross-section view of the insulation dam of FIG. 5, in accordance with one or more exemplary embodiments of the disclosure.

FIG. 7 is an exploded view of the insulation dam of FIG. 5, in accordance with one or more exemplary embodiments of the disclosure.

FIG. 8 is a cross-section view of a water heater including the insulation dam of FIG. 5, in accordance with one or more exemplary embodiments of the disclosure.

FIG. 9A is a perspective view of a water heater including another insulation dam, in accordance with one or more exemplary embodiments of the disclosure.

FIG. 9B is a side cross-section view of the water heater of FIG. 9A, in accordance with one or more exemplary embodiments of the disclosure

FIGS. 10-11 are exemplary process flows for assembling a water heater with an insulation dam, in accordance with one or more exemplary embodiments of the disclosure.

### DETAILED DESCRIPTION

Water-heating systems for heating water in residential settings, such as gas water heaters for homes or apartments, and methods for manufacturing the same, have been developed including an insulation dam facilitating more efficient and consistent assembly. The systems and methods disclosed herein may also be implemented in commercial and/or industrial water heating applications. The gas water heater may include a water tank positioned above a combustion chamber. The water tank and the combustion chamber may each be cylindrical. The combustion chamber may heat the water in the water tank, which may then be distributed throughout a house or other setting. A jacket which may be formed into a cylindrical shape may be positioned around the water tank and the combustion chamber and offset from the water tank and combustion chamber, forming an exterior housing together with a top pan.

To manage the heat generated by the combustion chamber and prevent undesired heat exchange with other components of the water heater, an insulating skirt may be positioned in a void between the combustion chamber and the jacket and may surround the combustion tank. The insulating skirt may be glued to or otherwise adhered to an insulation dam, which may surround a bottom region of the water tank and fill a void between the bottom region of the water tank and the jacket. The insulation dam may be an open cell foam and/or may be in a solid state and compressible.

An injectable insulation which may be a flowable foam (or any other type of foam or insulating material) may be inserted between the water tank and the jacket and top pan. Together the insulation dam and the injectable insulation may insulate the water tank and prevent undesired heat transfer between the water tank and the exterior environment and/or other components of the water heater. The insulation dam may be sized to fill the void between the bottom region of the water tank and the jacket, such that no injectable insulation is permitted to travel beyond the insulation dam and enter the void or compartment between the combustion chamber and the jacket.

To prevent injectable insulation from contacting the wall of the combustion chamber, an insulation bag may be positioned above the insulating skirt and filled with insulation (e.g., rising foam) prior to inserting injectable insulation between the water tank and the jacket and top pan.

The insulation bag may be filled to conform to an area between the bottom of the water tank and an exterior jacket of the water heater, such that the insulation bag forms a ring or annular structure. The insulation bag may be made of plastic which may have imperfections and/or may be susceptible to rips or rupture (e.g., due to over filling). When the insulation bags fail, the insulation inside the bag may escape and enter the void adjacent to the combustion chamber and/or the void between the water tank and the jacket. Rising foam on the combustion chamber wall may affect the performance of the water heater and/or may render the water heater inoperable. Insulation in the void between the water tank and the jacket could result in an overflow of injection insulation inserted into the void, as there may now be less volume for the injection insulation to occupy. Also, insulation bags with rising foam are known to result in inconsistent fill volumes which also affect the fill volume for the injection insulation.

Using an insulation bag is also labor intensive and creates undesirable complexities in the manufacturing process. For example, the insulation bag must be taped to the water heater assembly (e.g., to the water tank) and securing the bag and filling the bag with rising foam is often time-consuming and requires multiple individuals to install. Additionally, time is of the essence when installing and filling an insulation bag as the rising foam will reduce in volume when it cools and transitions from a flowable state to a hardened state.

The reduced volume in transitioning from flowable state to a hardened state is problematic as the purpose of the insulation bag is to create a barrier or dam, preventing the injectable insulation from reaching and entering the void adjacent to the combustion chamber. When the volume decreases, the injectable insulation may flow between the hardened insulation and the jacket and/or water tank and thus may enter the area around the combustion chamber.

To account for the transitive properties of the rising foam filled into the insulation bag, the injectable insulation must be quickly injected into the void between the water tank and the jacket immediately after the insulation bag is filled with rising foam. The immediacy required in injecting the injectable insulation must be accounted for in the schedules of laborers assembling the water heaters. To accommodate breaks, production must be suspended well before any such break or meal to avoid a situation where an insulation bag is filled immediately before a break and the injectable insulation is not inserted until after the break, at which point the rising foam in the insulation bag has hardened and thus reduced in volume.

In various aspects of the disclosure, to avoid the deficiencies with using an insulation bag, the insulation dam may be stable in volume as it does not transition between states. That is, the foam or other compressible solid in the insulation dam is already cured and retains a stable volume. Accordingly, the volume of injectable insulation needed may be easily and accurately determined. As there no time constraint involved with the assembly of the insulation dam, laborers may break at any time without disrupting or compromising the assembly of the water heaters. Further, as the insulation dam may be adhered to the insulating skirt and positioned onto the combustion chamber and the water tank at the same time, assembling a water tank with an insulation dam requires fewer laborers and thus is less labor intensive. As a result, more water heater units may be assembled per day with fewer laborers, saving both time and money.

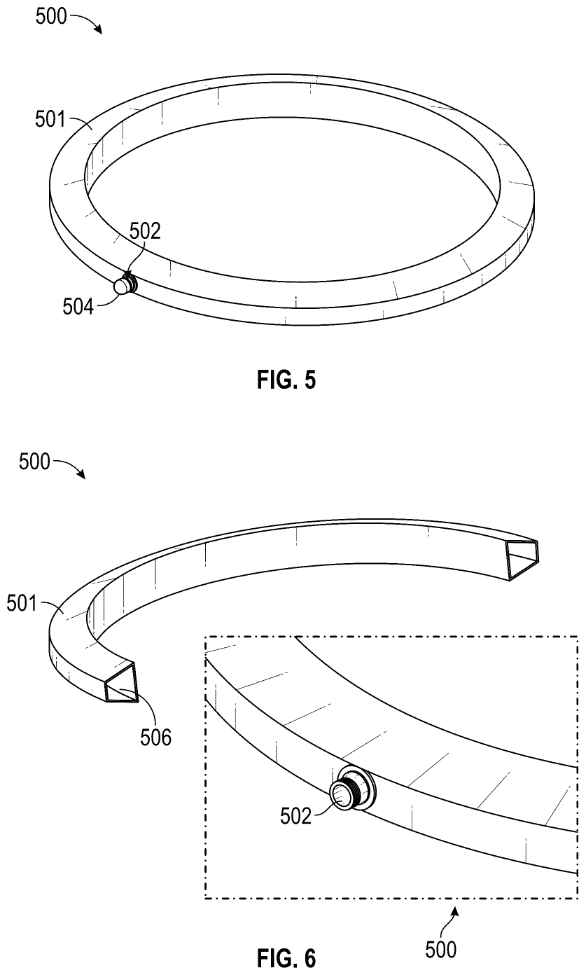

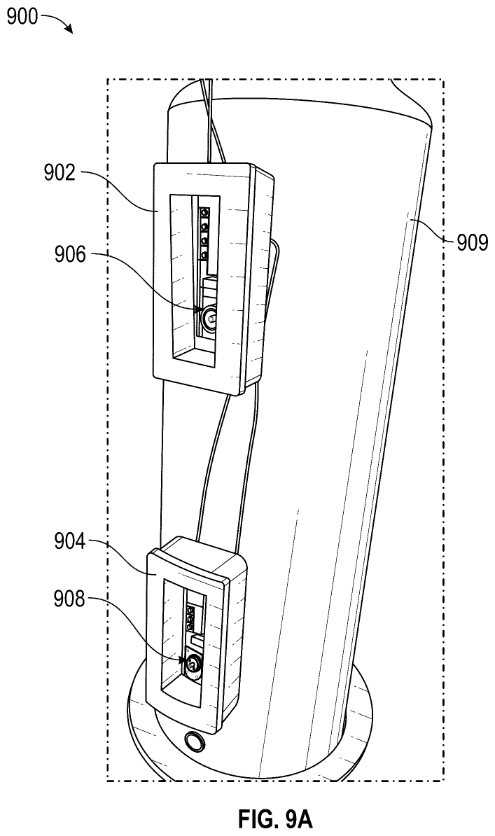

A further improvement associated with the systems and methods described herein involves the use of an insulation dam with an internal cavity filled with an open cell foam (this is shown in further detail in at least FIGS. 5-8). Open cell foam is still highly compressible after curing and can expand back to its original volume after being compressed. Accordingly, to provide for an easier installation process, prior to installation within the water heater, the air can be vacuumed out of the internal cavity of the insulation dam to compress the insulation dam. The insulation dam may then be situated around the surface of water tank (without a time constraint), the jacket may be provided over the insulation dam and the water tank, and air may then be introduced back into the internal cavity of the insulation dam. Introducing the air back into the internal cavity fills the open cell foam with air, causing the insulation dam to expand again and compress against the surface of the water tank and the jacket, thereby creating a structure within the void between the water tank and the jacket. Thus, when the injectable foam is inserted into the void, it is prevented from passing through the insulation dam (for example, downwards into the combustion chamber as shown in FIG. 8).

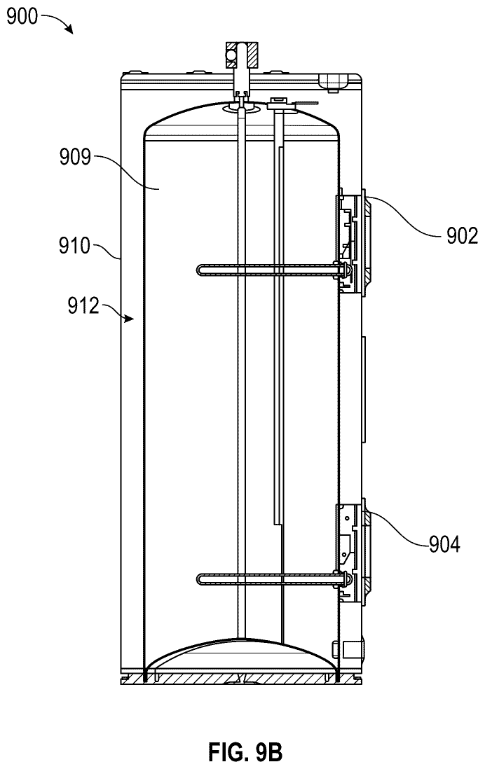

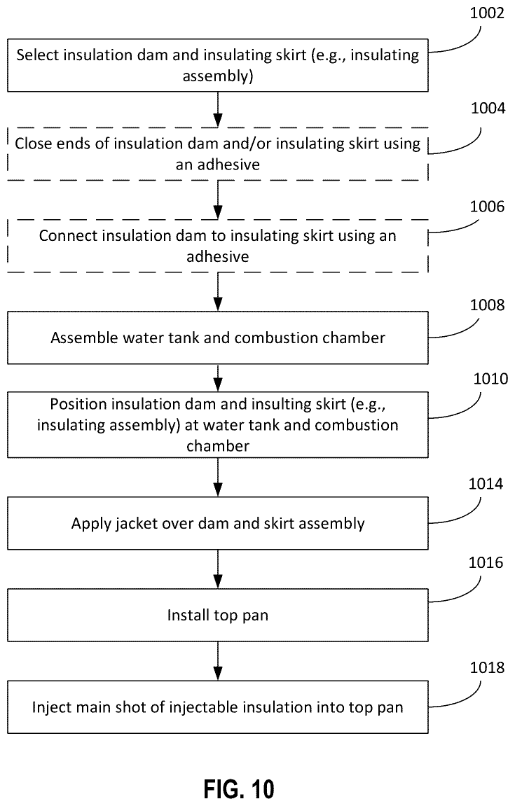

While reference is made herein to gas water heaters, it should be noted that the systems and methods described herein may also be applicable to other types of water heaters, such as electric water heaters. FIGS. 9A-9B show another embodiment of a foam dam that may be used with electric water heaters that may be used to protect the electronics of the electric water heater from foam that is injected between the surface of the water tank and the jacket provided around the water tank. Additionally, while reference is made to water heaters used in residential settings, the systems and methods described herein may also be applicable to water heaters used in other settings as well, such as commercial settings, for example.

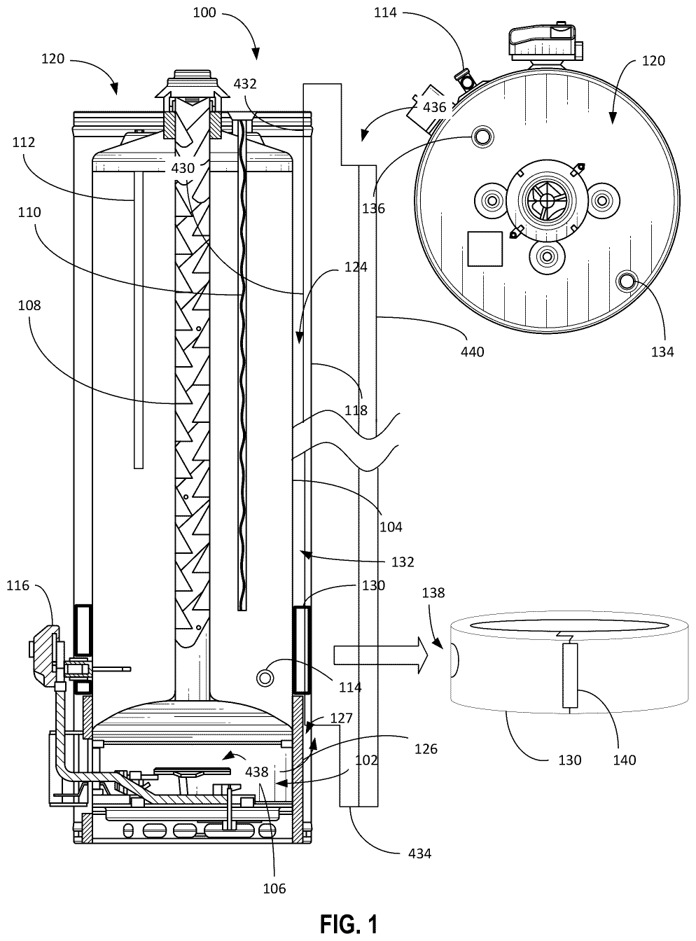

Referring now to FIG. 1, a water heater, which may be for residential use, is illustrated and may include an insulation dam for preventing injectable insulation from entering an area near the combustion chamber including a gas water heater. As shown in FIG. 1, water heater 100 may be a gas water heater intended for supplying heated water in a residential setting. Water heater 100 may be generally cylindrical in shape and may include components of any suitable water heater.

Water heater 100 may include combustion chamber 102 and water tank 104. Combustion chamber 102 may be any suitable combustion chamber for heating a water and/or pressurized tank containing a volume of water. Water tank 104 may be any suitable water or pressurized tank and may be designed to hold a volume of water. Water tank 104 and/or combustion chamber 102 may be generally cylindrical and/or water tank 104 may be positioned above combustion chamber 102.

Combustion chamber 102 may include burner 106 which may be any suitable gas burner designed to burn fuel (e.g., natural gas) and may receive fuel via a fuel line. The burner may direct heat towards water tank 104 for heating the water in water tank 104. Exhaust from combustion chamber 102 may escape water heater 100 via flue baffle 108, which may be any suitable flue baffle and may extend through water tank 104.

Water tank 104 may further include anode 210 and/or water tube 112 which may be an inlet or outlet tube for a water inlet or outlet into water tank 104. It is understood that multiple water inlet and/or outlet tubes may be positioned in water tank 104. Additionally, water tank 104 may include drain 114 and/or control unit 116. Drain 214 may be used to drain water out of a bottom region of the water tank. Control unit 116 may be used to control one or more functions of water heater 102 such as the gas line and/or may be connected to a temperature sensor.

As shown in FIG. 1, jacket 118 may be positioned around water tank 104 and combustion chamber 102 such that water tank 104 and/or combustion chamber 102 is fully surrounded by jacket 118. Jacket 118 may be arranged and/or assembled to form a generally cylindrical structure with an open top end. The opened top end may be coupled to top pan 120, which may be generally circular, disk, or domed-shaped. Top pan 120 may include one or more through holes. For example top pan 102 may include through hole 122 and/or through hole 124. A bottom pan may optionally be positioned at a bottom end of jacket 118.

Jacket 118 may be offset circumferentially from water tank 104 and/or combustion chamber 106 to create one or more voids or compartments. Void 124 may be defined by an interior surface of jacket 118, an interior surface of top pan 120, and an exterior surface of water tank 104. Similarly, void 127 may be formed by an exterior surface of combustion chamber 102 and an interior surface of jacket 118. Each void may initially be filled with air.

Void 127 may extend the length of the combustion chamber. Insulating skirt 126 may be inserted into void 127 and may serve to insulate combustion chamber 102, reducing undesirable heat transfer of heat generated by the combustion chamber. Insulation skirt 126 may be any suitable insulation material, such as fiberglass insulation material for example. Insulation skirt 126 may be rectangular in shape and may have two ends that are adhered or otherwise secured to form an annular or generally cylindrical structure. Insulation skirt 126 may include one or more voids for the gas line and other burner components.

Insulation dam 130 may be positioned above void 127 and may be adhered to insulating skirt 126. For example, insulation dam 130 may glued and/or taped to insulating skirt 126. Insulation dam 130 may have a wall thickness that is thicker than insulating skirt 126. For example, insulation dam 130 may have a wall thickness that is the same as the distance between an outer surface of water tank 104 and an inner surface of jacket 118. Alternatively, insulation dam 130 may have a thickness that is larger than the distance between an outer surface of water tank 104 and an inner surface of jacket 118 and may be compressed when jacket 118 is assembled and secured to water tank 104.

Insulation dam 130 may be any suitable compressible foam such as open cell foam. Insulation dam 130 may be stable in that it may be in a solid state, though it may be pliable and/or compressible. Insulation dam 130 may be positioned in void 124 near a bottom region of water tank 104 such that the top of insulation dam 130 may form a third void, void 132, with an interior surface of jacket 218, an exterior surface of water tank 104, and an interior surface or top pan 120.

With insulation dam 130 in place, injectable insulation (e.g., a foam that is at least initially flowable and may transition into a hardened state) may be inserted into a through hole of top pan 120 (e.g., through hole 234). The injectable insulation may fill void 132 and may cause air in void 132 to evacuate via a second through hole in top pan 120 (e.g., hole 136). As injectable foam fills void 132, insulation dam 130 resists and prevents the flow of injectable insulation into void 127. As the size of insulation dam 130 and void 132 may be constant and known, the amount of injectable insulation needed to fill void 132 may also be constant and known, increasing efficiency and reducing waste in the manufacturing process.

As shown in FIG. 1, insulation dam 130 may be annular and/or cylindrical in shape. For example, insulation dam 130 may be a generally rectangular shape that may be formed into an annular shape by adhering two ends of the rectangular shape together. For example, tape 140 and/or any other adhesive (e.g., glue) may be used to secure the two ends together. Insulation dam 130 may include one or more through portions or voids extending through a wall of insulation dam (e.g., void 138). Each void may be aligned with a component extending through the wall of jacket 118 and/or water tank (e.g., control unit 116, temperature sensor, drain 114, etc.).

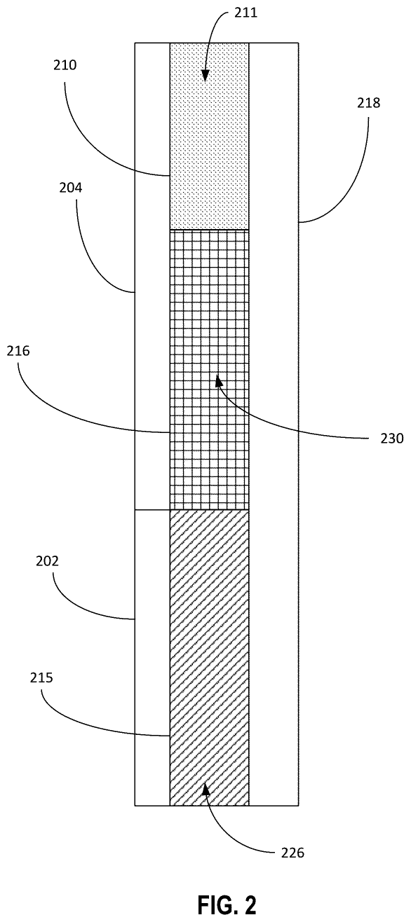

Referring now to FIG. 2, a cross-section of a wall of a water heater, such as water heater 100 is illustrated. As shown in FIG. 2, one side of the wall of the water heater may be jacket 218, which may be the same as or similar to jacket 218 of FIG. 2. Wall 204 may be a wall of a water tank, which may be the same as or similar to water tank 104 of FIG. 1. Wall 202 may be a wall of a combustion chamber, which may be the same as or similar to combustion chamber 102 of FIG. 1. Wall 204, wall 202 and/or jacket 218 may be metallic (e.g., steel), for example, or any other suitable material (e.g., fiberglass)

Void 215 may be formed between wall 202 and/or jacket 218. Void 215 may be the same as or similar to void 127 of FIG. 1. Insulating skirt 226 may be positioned in void 215 and/or may occupy all or a portion of void 215. Insulating skirt 226 may be the same as or similar to insulating skirt 126 of FIG. 1. Void 216 may be formed between wall 204 and jacket 218 and may be the same as or similar to void 124 of FIG. 1. Void 216 may be occupied by insulation dam 230, which may be the same as or similar to insulation dam 130 of FIG. 1. Void 210 may be defined by a top portion of insulation dam 230, wall 204, and jacket 218. Void 210 may be occupied by injectable insulation 211. It is understood that insulation dam 230 may be positioned adjacent to and/or on top of insulating skirting 226 and/or insulation dam 230 may partially overlap insulating skirt 226.

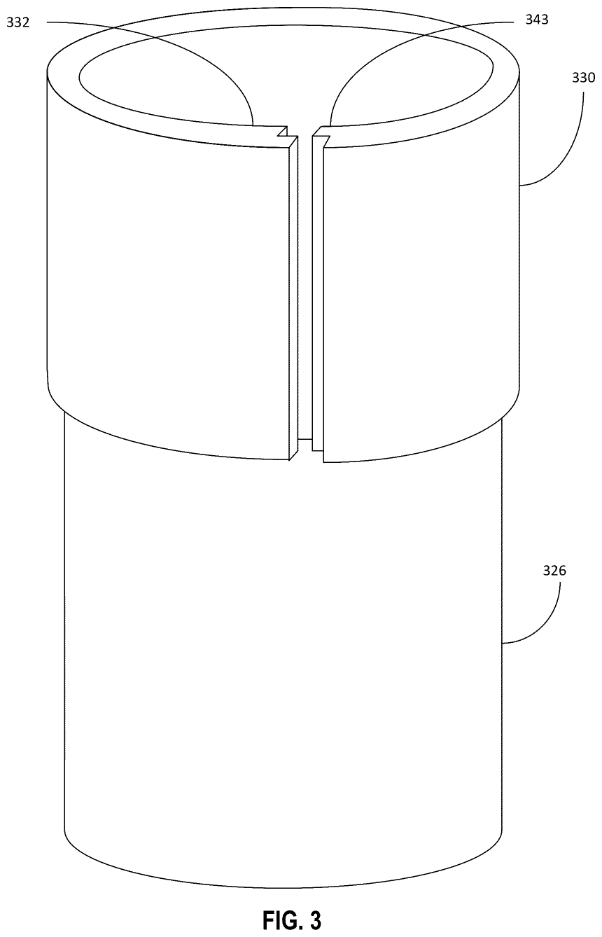

Referring now to FIG. 3, an insulation assembly including an insulation dam adhered to an insulating skirt is illustrated. As shown in FIG. 3, insulation dam 330 may be positioned above insulating skirt 326 and may be adhered to and/or otherwise secured to insulation dam 330. Insulation dam 330 may be the same as or similar to insulation dam 130 of FIG. 1. Insulating skirt 326 may be the same as or similar to insulating skirt 226 of FIG. 1. Insulation dam 330 may be secured to insulating skirt 326 via any suitable adhesion technique such as, glue and/or tape for example.

As shown in FIG. 3, insulating skirt 326 may have a wall thickness and/or outer diameter that is less than that of insulation dam 330. Alternatively, insulating skirt 326 and/or insulation dam 330 may have the same outer diameter and/or wall thickness as insulation dam 330. Insulation dam 330 may have two ends, end 332 and/or end 334. Insulation dam 330 may be formed into the cylindrical or annual shape shown in FIG. 3 and end 332 and/or end 334 may be mated and secured to one another via adhesion (e.g., via any suitable glue and/or tape).

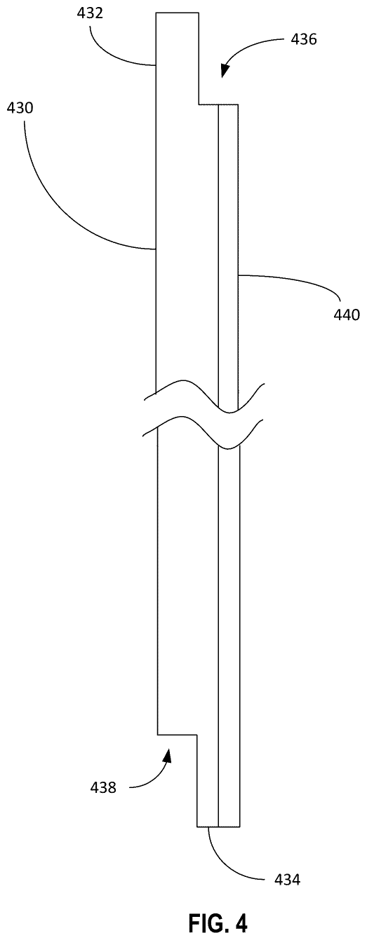

Referring now to FIG. 4, a top down view of an exemplary unformed installation dam is illustrated. Specifically, insulation dam 430 is illustrated in an unformed fashion. Insulation dam 430 may be the same as or similar to insulation dam 130 of FIG. 1. Insulation dam 430 may be cut into sheets (e.g., from a roll). Insulation dam 430 may include end 432 an end 434.

End 432 and end 434 may include notches 436 and 438, respectively, which may be square notches (e.g., rabbet joint) and/or any other suitable notch shape such that a portion of end 432 may be received by end 434 and/or vice versa. Each notch may include an adhesive that secures ends 432 and 434 together and creates flush and congruent inner and outer surfaces. In one example, insulation dam 430 may include step 440, which may be a notch and/or protrusion. For example, the insulation skirt may have a wall thickness less than insulation dam 430 and insulation dam 430 may have a step and/or notch sized and shaped to receive a portion of insulation skirt such that at least a portion of insulation dam 430 overlaps the insulating skirt. Alternatively, insulation dam may not include step 440.

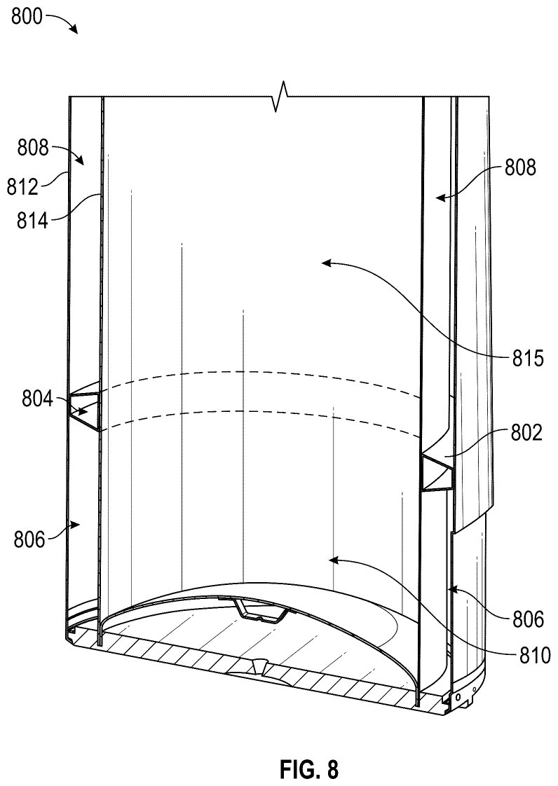

Referring now to FIG. 5, a perspective view of another insulation dam 500 is shown. FIG. 7 shows an exploded view of insulation dam 500 of FIG. 5. Similar to insulation dam 130 of FIG. 1, insulation dam 500 may be provided in between the surface of the water tank and the inner surface of the jacket and may resist and prevent the flow of injectable insulation into certain regions of the water heater, such as the combustion chamber. Further details about the arrangement of insulation dam 500 within a water heater are provided with respect to FIG. 8.

Insulation dam 500 may be a tube made from any flexible material (e.g., rubber, etc.). Although insulation dam 500 is shown as being provided in a particular shape, this shape is merely exemplary and any other shape may also be used. Additionally, although insulation dam 500 is shown as being one continuous piece, insulation dam 500 may similarly be formed from multiple individual pieces that are combined together in any suitable manner.

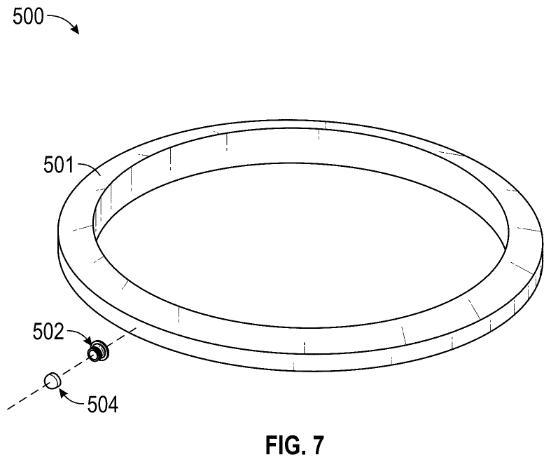

Insulation dam 500 may also include valve 502. Provided on valve 502 may be a cap 504 that may prevent air from entering an internal cavity (shown as internal cavity 506 in FIG. 6) of insulation dam 500 (although the figure only shows a single valve 502 and cap 504, any other number of valves 502 and caps 504 may similarly be provided at various other locations on insulating dam 500). For example, cap 504 may be added on valve 502 to prevent air from entering internal cavity 506 and cap 504 may be removed from valve 502 to allow air to enter internal cavity 506. In some instances, valve 502 may be pierced after cap 504 is removed to allow air to enter internal cavity 506, however, this may not be necessary and valve 502 may be configured to allow air to enter internal cavity 502 simply by removing cap 504.

Prior to installation of insulation dam 500 within the water heater, insulation dam 500 may be filled with a foam, such as an open-cell foam (e.g., flexible polyurethane or any other type of open-cell foam). Once the foam is added to internal cavity 506 of insulation dam 500, air may be vacuumed out from the interior of insulation dam 500 via valve 502. Vacuuming the air from insulation dam 500 causes insulation dam 500 to compress, allowing for ease of installation around the water tank (as shown in FIG. 8).

Once insulation dam 500 is installed around the water tank, cap 504 may be removed from valve 502 (and valve 502 may be pierced, if required), causing air to fill within internal cavity 506 of insulation dam 500. The air entering internal cavity 506 of insulation dam 500 causes insulation dam 500 to expand and compress against the water tank and the jacket. Performing the installation in this manner allows for insulation dam 500 be to easily installed while still allowing for insulation dam 500 to expand to securely fit between the water tank and the jacket post-installation to prevent any foam that is inserted above insulation dam 500 from traveling below insulation dam 500 (for example, into the combustion chamber). Insulation dam 500 may either be provided around the water tank before the jacket is provided over the water tank or insulation dam 500 may be provided between the water tank and the jacket after the jacket is provided over the water tank.

The use of valve 502 and cap 504 is merely one exemplary mechanism by which air is added to and/or removed from internal cavity 506 of insulation dam 506 (and/or any other insulation dam described herein), and any other mechanism may also be used.

Referring now to FIG. 8, a cross-section view of a water heater 800 including the insulation dam (shown as insulation dam 802 in FIG. 8) of FIG. 5 is shown. FIG. 8 shows that insulation dam 802 is provided around outer surface 814 of water tank 815 of water heater 800. A foam may be provided within internal cavity 804 of insulation dam 802 prior to installation of insulation dam 802 around water tank 815. For example, the foam may be an open-cell foam. When insulation dam 802 in installed around water tank 815, two voids are created on either side of insulation dam 802. First void 808 is created between outer surface 814 of water tank 815 of water heater 800 and jacket 812 above insulation dam 802. Second void 806 is created between combustion chamber 810 and jacket 812 below insulation dam 802. In some instances, insulation dam 804 may be adhered to outer surface 814 of water tank 815 or may be secured to a particular position on outer surface 814 of water tank 815 using any other suitable mechanism.

With insulation dam 802 in place as shown in FIG. 8, injectable insulation may be inserted into first void 808. The injectable insulation may fill first void 808 and may cause air in first void 808 to evacuate. As injectable foam fills first void 808, insulation dam 802 resists and prevents the flow of injectable insulation into second void 806. Thus, insulation dam 802 serves to prevent injectable insulation from entering the combustion chamber, which may be undesirable. Although insulation dam 800 is shown as being provided at a specific position between outer surface 814 of water tank 815 of water heater 800 and jacket 812, insulation dam 802 may also be provided at any other position. Additionally, multiple insulation dams may also be provided. Finally, insulation dam 802 may also be any other size and/or shape as well, and may also be made from any other material, such as a plastic, etc.

Prior to installation within water heater 800, air can be vacuumed out of insulation dam 802 to compress insulation dam 802. Insulation dam 802 may then be provided around surface 814 of water tank 815, jacket 812 may be provided over insulation dam 802 and water tank 815, and air may then be introduced back into internal cavity 804 of insulation dam 802 (for example, by removing a cap from a valve of insulation dam 802 (and piercing the valve, if necessary). Introducing the air back into internal cavity 804 fills the open cell foam with air, causing insulation dam 802 to expand again and compress against the surface 814 of water tank 815 and jacket 812, thereby creating the secure insulation dam between water tank 815 and jacket 812.

Referring now to FIG. 9A, a perspective view of a water heating including additional insulation dams (for example, insulation dam 902 and insulation dam 904) is shown. A side cross-section view of the water heater 900 of FIG. 9A is shown in FIG. 9B as well. FIGS. 9A-9B show that the insulation dams may not necessarily be limited to only ring-shaped dams that prevent foam from reaching a combustion chamber of a gas water heater (as shown in FIG. 8). FIG. 9A also shows that the insulation dams may also be provided in any other size and/or shape as well. For example, insulation dam 902 and insulation dam 904 are rectangular-shaped foam provided around electronics 906 and 908 of the electric water heater 900.

Similar to insulation dam 500 and insulation dam 800, insulation dam 902 and insulation dam 904 may be provided between outer surface of water tank 909 and the inner surface of jacket 910. Insulation dam 902 and insulation dam 904 prevent foam that is injected into void 912 between outer surface of water tank 909 and the inner surface of jacket 910 from reaching electronics 906 and 908. While FIGS. 9A and 9B only show two insulation dams (insulation dam 902 and insulation dam 904), any other number of insulation dams may similarly be provided based on the amount and positioning of the electronics on the water heater 900.

Insulation dam 902 and insulation dam 904 may be provided at a thickness such that when jacket 910 is provided around water tank 909, insulation dam 902 and insulation dam 904 are in contact with water tank 909 and jacket 910. However, while insulation dam 902 and insulation dam 904 are shown as being a foam material, insulation dam 902 and insulation dam 904 (or any other insulation dam used with an electric water heater) may also be provided as a flexible tube filled with foam, similar to insulation dam 500, insulation dam 802, etc.

In some instances, an insulation, such as a fiberglass insulation may also be provided within insulation dam 902 and insulation 904 over the electronics included within insulation dam 902 and insulation dam 904.

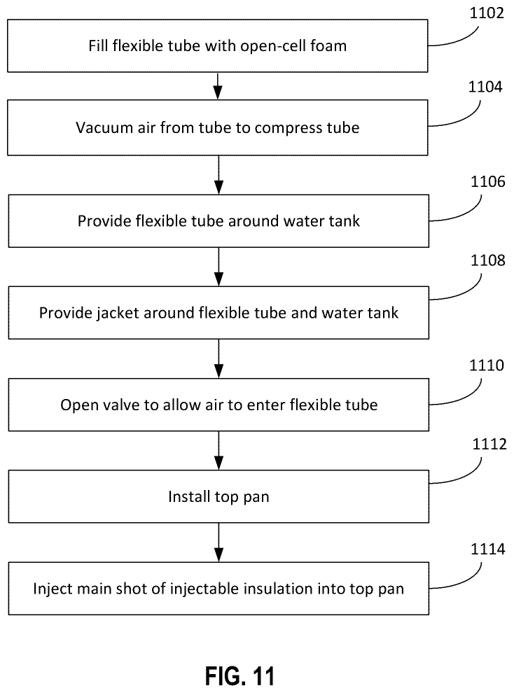

Referring now to FIG. 10, an exemplary process flow for assembling a gas water heater with an insulation dam is illustrated. It is understood that one or more steps of FIG. 10 may be optional and/or the one or more steps of FIG. 10 may be performed in a different order. To initiate the process illustrated in FIG. 10, at block 1002, an insulation dam and an insulating skirt may be selected. For example, an insulating assembly including an insulation dam adhered to an insulating skirt may be selected. In one example, the insulation dam may be the same as or similar to insulation dam 130 and/or the insulating skirt may be the same as or similar to insulating skirt 126.

At optional block 1004, the ends of the insulation dam and/or the ends of the insulating skirt may be connected using an adhesive to form an annular or cylindrical structure. For example, the ends of the insulation dam may be glued and/or taped and the ends of the insulating skirt may be connected using glue and/or tape. At optional block 1006, the insulation dam may be connected to the insulating skirt via an adhesive (e.g., glue and/or tape). It is understood that insulation dam and insulating skirt may be selected individually or in their preassembled (e.g., already adhered or otherwise connected) form.

At block 1008, a water tank and combustion chamber may be assembled. Additionally, ancillary components may further be assembled such as a bottom pan or structure supporting the combustion chamber, a control unit, a gas line, a temperature sensor, a flue baffle, and/or the like. At block 1010, the insulating assembly (e.g., including the insulating skirt adhered to the insulation dam) may be positioned over the water tank and combustion chamber such that the combustion chamber is surrounded by the insulating skirt and a bottom region of the water tank is surrounded by the insulation dam.

As the insulating assembly may be positioned around the water tank and combustion chamber at the same time, time may be saved as compared to using the insulation bag with the rising foam. At block 1014, a jacket such as jacket 118 of FIG. 1 may be positioned around the insulating assembly, water tank, and the combustion chamber. The jacket may form compartments and/or voids in which injectable insulation may be inserted.

At block 1016, a top pan may be installed onto the jacket completing the compartments and voids. Optionally a bottom pan may be positioned below the combustion chamber. The top pan may include through holes. At block 1018, a main shot of insulation may be inserted via the through holes on the top pan. For example, foam insulation may be injected into one hole in the top pan to fill an open void between the jacket wall and the water tank. Due to the insulation dam, the injectable insulation will not flow into or otherwise migrate into the void adjacent to the combustion chamber.

Referring now to FIG. 11, another exemplary process flow 1100 for assembling a gas water heater with an insulation dam is illustrated. It is understood that one or more steps of FIG. 11 may be optional and/or the one or more steps of FIG. 11 may be performed in a different order. To initiate the process illustrated in FIG. 11, at block 1102, the internal cavity of a flexible tube that is used to form an insulation dam may be filled with an open-cell foam. At block 1104, air may be vacuumed from the internal cavity of the flexible tube to compress the flexible tube for installation.

At block 1106, the flexible tube may then be installed around the water tank. The flexible tube may be provided at a location on the water tank such as to prevent any foam that is injected between the water tank and the jacket that is installed around the water tank from reaching certain portions of the void created between the water tank and the jacket, such as the combustion chamber (or any other location). At block 1108, the jacket may be provided around the water tank and the flexible tube. In some instances, the jacket may be provided around the water tank and then the flexible tube may be inserted into the region between the water tank and the jacket.

At block 1110, once the flexible tube is installed around the water tank, the valve provided on the flexible tube may be opened to allow for air to re-enter the internal cavity of the flexible tube. For example, a cap may be provided on the valve and the cap may be removed from the valve to allow air to enter the internal cavity. The air may also be re-introduced into the internal cavity in any other suitable manner (for example, the valve may be pierced, etc.). Given that the foam provided in the internal cavity of the flexible tube is open-cell foam, introducing the air back into the internal cavity causes the open-cell foam to expand, thereby expanding the flexible tube.

At block 1112, a top pan may be installed onto the jacket completing the compartments and voids. Optionally a bottom pan may be positioned below the combustion chamber. The top pan may include through holes. At block 1114, a main shot of insulation may be inserted via the through holes on the top pan. For example, foam insulation may be injected into one hole in the top pan to fill an open void between the jacket wall and the water tank. Due to the insulation dam, the injectable insulation will not flow into or otherwise migrate into the void adjacent to the combustion chamber.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A method for making a water heater, the method comprising:
filling an internal cavity of an insulation dam with a foam, wherein the insulation dam comprises a valve;
removing air from the internal cavity of the insulation dam via the valve to compress the insulation dam;
positioning the insulation dam around a water tank of the water heater;
positioning a jacket around the insulation dam and the water tank; and
re-introducing air back into the internal cavity of the insulation dam via the valve to expand the insulation dam against the water tank and the jacket; and
injecting an injectable insulation into a first compartment formed between the water tank and the jacket on a first side of the insulation dam to fill the first compartment with the injectable insulation,
wherein the insulation dam prevents the injectable insulation from entering a second compartment on a second side of the insulation dam.

2. The method of claim 1, wherein the water heater further comprises a combustion chamber comprising a burner and wherein the second compartment is formed between the combustion chamber and the jacket on the second side of the insulation dam.

3. The method of claim 1, wherein the insulation dam is a flexible tube.

4. The method of claim 1, wherein the foam is an open-cell foam.

5. The method of claim 1, further comprising:
coupling a top pan comprising a first through hole to a top of a structure formed by the jacket,
wherein the injectable insulation is injected through the first through hole.

6. The method of claim 1, further comprising:
adhering the insulation dam to a surface of the water tank.

7. The method of claim 1, wherein re-introducing air to the internal cavity further comprises removing a cap from the valve.

8. The method of claim 1, wherein the air is re-introduced into the insulation dam subsequent to the jacket being positioned around the water tank and the insulation dam.

9. The method of claim 1, wherein the jacket forms a cylindrical structure around the water tank and the insulation dam.

10. A water heater comprising:
a water tank;
a jacket disposed around the water tank, the jacket and the water tank forming a first void; and
an insulation dam disposed around the water tank, the insulation dam comprising an internal cavity and a valve,
wherein the internal cavity of the insulation dam is configured to be filled with a foam such that air is removed from the internal cavity prior to installation of the insulation dam around the water tank,
wherein air is re-introduced into the internal cavity via the valve subsequent to installation of the insulation dam around the water tank, and
wherein the insulation dam is configured to prevent injectable insulation from entering a second void formed between the water heater and the jacket.

11. The water heater of claim 10, further comprising:
a combustion chamber comprising a burner, the jacket and the combustion chamber forming the second void.

12. The water heater of claim 11, wherein the combustion chamber is located below the water tank and the second void is located below the first void.

13. The water heater of claim 10, wherein the foam is an open-cell foam.

14. The water heater of claim 10, wherein the insulation dam is configured to compress when the air is removed from the internal cavity and expand when the air is re-introduced into the internal cavity.

15. The water heater of claim 10, wherein the insulation dam is a flexible tube.

16. The water heater of claim 10, wherein the insulation dam is adhered to a surface of the water tank.

17. The water heater of claim 10, further comprising a top pan.

18. The water heater of claim 17, wherein the jacket is configured to form a cylindrical structure and is coupled the top pan at a top end of the cylindrical structure.

19. The water heater of claim 10, wherein the insulation dam further comprises a cap provided over the valve.

20. A residential water heater comprising:
a combustion chamber comprising a burner;
a water tank disposed above the combustion chamber and having a top region and a bottom region;
a top pan comprising a first through hole;
a jacket disposed around the water tank and the combustion chamber, the jacket configured to form a cylindrical structure and coupled the top pan at a top end of the cylindrical structure, the jacket and the combustion chamber forming a first void and the jacket, the top pan, and the water tank forming a second void;
an insulating skirt disposed around the combustion chamber in the first void; and
an insulation dam disposed around the water tank and comprising a first end and a second end coupled to the first end to form an annular shape, the insulation dam positioned adjacent to the insulating skirt at the bottom region of the water tank, the top pan, the jacket, and the insulation dam defining a third void within the second void, wherein the third void is configured to receive an injectable insulation into the first through hole of the top pan such that the injectable insulation occupies the third void, and wherein the insulation dam is configured to prevent the injectable insulation from entering the first void.
